(19) United States
(12) Patent Application Publication
(10) Pub. No.: US 2008/0177766 A1
(43) Pub. Date: Jul. 24, 2008

(54) IMAGE FORMING APPARATUS AND CONTROL METHOD THEREOF

(75) Inventor: Sang Hyun PARK, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/014,907

(22) Filed: Jan. 16, 2008

(30) Foreign Application Priority Data
Jan. 19, 2007 (KR) 2007-0006123
Dec. 26, 2007 (KR) 2007-0137725

(51) Int. Cl. G06F 17/30

(52) U.S. Cl. 707/100; 707/E17.005

(57) ABSTRACT

An image forming apparatus and a control method thereof to manage image files by automatically classifying the image files. The control method includes creating a memory day log file having a type and date information of a memory day, comparing date information of an image file to be worked with date information of the memory day log file, and storing the image file by creating a second memory day folder to store the image file when a first memory day folder corresponding to the date information of the image file is not created.

### CROSS-REFERENCE TO RELATED APPLICATIONS

This application claims priority under 35 U.S.C. §119(a) from Korean Patent Application Nos. 10-2007-0006123 filed Jan. 19, 2007, and 10-2007-0137725 filed Dec. 26, 2007, in the Korean Intellectual Property Office, the disclosure of which are incorporated herein in their entirety by reference.

### BACKGROUND OF THE INVENTION

1. Field of the Invention

The present general inventive concept relates generally to an image forming apparatus and a control method thereof, and more particularly to an image forming apparatus and a control method thereof, capable of easily managing image files photographed on a memory day.

2. Description of the Related Art

Generally, photographs (hereinafter, referred to as “image files”) taken by a digital photographing device are stored in storage media embedded in or storage media (e.g., memory cards, etc) inserted into the digital photographing device, and a user can transfer the image files stored in the storage media to image forming apparatuses (e.g., a printing unit, a multifunctional peripheral (MFP), etc.) such that the image forming apparatuses can print the image files.

The image forming apparatus stores image files transferred from an external device in an embedded large-capacity storage unit and then prints the image files according to a user's request. The image files of the embedded large-capacity storage unit are automatically stored in folders automatically created according to a photographing time of the image files and a naming rule of the image forming apparatus.

However, conventionally, since folders are created, and image files are stored according to the photographing time of the image files and the naming rule of the image forming apparatus, image files photographed on particular memory days or at ordinary times are mixed with each other. Accordingly, if a user intends to print the image files photographed on memory days, he/she individually must search for and print the image files photographed on particular memory days among the image files stored in the large-capacity storage unit, so that a printing work may be complex and requires much time with respect to the image files photographed on memory days.

### SUMMARY OF THE INVENTION

The present general inventive concept provides an image forming apparatus and a control method thereof, capable of easily managing image files photographed on memory days.

Additional aspects and/or advantages of the general inventive concept will be set forth in part in the description which follows and, in part, will be obvious from the description, or may be learned by practice of the general inventive concept.

The foregoing and/or other aspects and utilities of the present general inventive concept are achieved by providing a control method of an image forming apparatus, including creating a memory day log file having a type and date information of a memory day, comparing date information of an image file with the date information of the memory day log file, and storing the image file by creating a second memory day folder to store the image file when a first memory day folder corresponding to the date information of the image file is not created.

A memory day folder of the memory day log file may be created when the memory day log file is created.

The comparing of the date information may include determining that the date information of the image file is identical to the date information of the memory day log file.

The storing of the image file may include storing the image file in the first memory day folder when the first memory day folder corresponding to the date information of the image file is created.

The control method may further include notifying a user of an absence of the first memory day folder corresponding to the date information of the image file when the first memory day folder is not created.

The control method may further include printing the stored image file in a folder unit.

The foregoing and/or other aspects and utilities of the present general inventive concept are also achieved by providing an image forming apparatus including a storage unit which creates a memory day log file having a type and date information of a memory day, and a controller which compares date information of an image file with the date information of the memory day log file so as to store the image file by creating a second memory day folder to store the image file when a first memory day folder corresponding to the date information of the image file is not created.

The storage unit may create a memory day folder of the memory day log file when the memory day log file is created.

The controller may perform a control operation such that the image file is stored in the first memory day folder when the first memory day folder corresponding to the date information of the image file is created in the storage unit.

The image forming apparatus may further include a display unit, wherein the controller controls the display unit to notify a user of an absence of the first memory day folder corresponding to the date information of the image file when the first memory day folder is not created.

The image forming apparatus may further include an input unit which inputs a user's command to modify the memory day log file, wherein the controller receives a type and date information of a memory day to be modified by using the memory day log file through the input unit and modifies the first and second memory day folders according to the received information.

The image forming apparatus may further include a printing unit, wherein the controller controls the printing unit to print out the image file in a folder unit.

The foregoing and/or other aspects and utilities of the present general inventive concept are also achieved by providing a control method of an image forming apparatus, the control method includes generating a memory day log file including memory day type and date information, comparing date information of an image file to the date information of the memory day log file, and storing the image file in a memory day folder, wherein the image file is stored in a first memory day folder corresponding to the date information of the memory day log file when the date information of the memory day log file corresponds to the date information of the image file, and the image file is stored in a second memory day folder generated to correspond with the date information of the image file when the date information of the memory day log file does not correspond to the date information of the image file.

The image forming apparatus may request a user to generate the second memory day folder when the date information of the memory day log file does not correspond to the date information of the image file.

The foregoing and/or other aspects and utilities of the present general inventive concept are also achieved by providing a control method of an image forming apparatus, the control method including determine whether date information of an image file is present, analyze a memory day log file to determine whether the date information of the image file corresponds to date information of the memory day log file, store the image file in a memory day folder corresponding to the date information of the image file.

The image file may be stored in a first memory day folder corresponding to the date information of the memory day log file when the date information of the image file corresponds to date information of the memory day log file.

A second memory day folder may be generated to store the image file when the date information of the image file does not correspond to date information of the memory day log file.

Image files within a memory day folder may be further stored in sub-folders corresponding to a type, sub-type, or sub-date information of the image file.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating an image forming apparatus to automatically manage image files according to one embodiment of the present general inventive concept;

FIG. 2 is a view illustrating a structure of a memory day log file used in an image forming apparatus according to an embodiment of the present general inventive concept;

FIG. 3 is a view illustrating an example of a memory day log file used in an image forming apparatus according to an embodiment of the present general inventive concept;

FIG. 4 is a view illustrating a structure of folders used to automatically manage image files according to one embodiment of the present general inventive concept;

FIG. 5 is a first view illustrating a structure of a display unit illustrated in FIG. 1;

FIG. 6 is a second view illustrating the structure of a display unit illustrated in FIG. 1;

FIG. 7 is a third view illustrating the structure of a display unit illustrated in FIG. 1;

FIG. 8 is a fourth view illustrating the structure of a display unit illustrated in FIG. 1;

FIG. 9 is a view illustrating a selection input window used to store an image file according to one embodiment of the present general inventive concept;

FIG. 10 illustrates a selection input window to display a failure message to inform a failure in storage of an image and creating a folder according to one embodiment of the present general inventive concept; and

FIG. 11 is a flowchart illustrating a control method of an image forming apparatus which automatically manages image files according to one embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

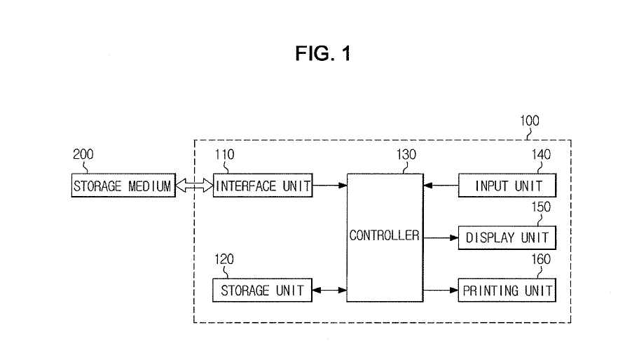

FIG. 1 is a block diagram illustrating an image forming apparatus to automatically manage image files according to one embodiment of the present general inventive concept. The image forming apparatus 100 may include an interface unit 110, a storage unit 120, a controller 130, an input unit 140, a display unit 150, and a printing unit 160. The image forming apparatus 100 is connected to a storage medium 200 through the interface unit 110.

The storage medium 200 may include a recording medium embedded in or inserted into a digital photographing device, and stores a plurality of image files, which includes image files photographed on memory days and at ordinary times, in a digital format, such as a JPEG format. The JPEG image file can include information about a photographing time and date, a shutter speed, an aperture ratio, a zoom ratio, resolution, and a use of flash, and such photographing information can be stored on a header of the JPEG image file.

The interface unit 110 allows the storage medium 200 to interface with the image forming apparatus 100 when the storage medium 200 is inserted from an exterior.

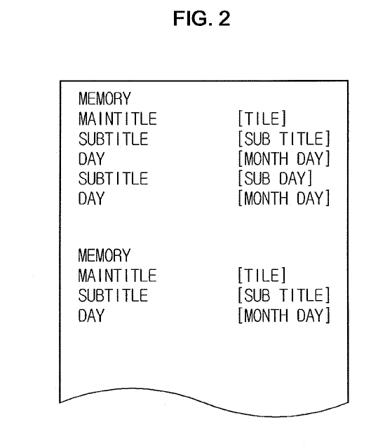

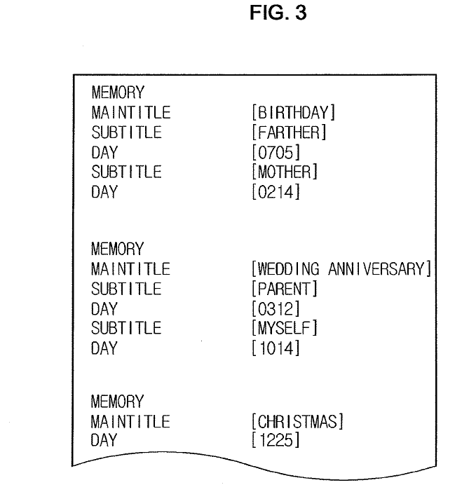

The storage unit 120 can be an embedded large-capacity storage device to store image files transferred from the storage medium 200 through the interface unit 110, and has a memory day log file used to classify and manage stored image files according to user's intention (see FIGS. 2 and 3).

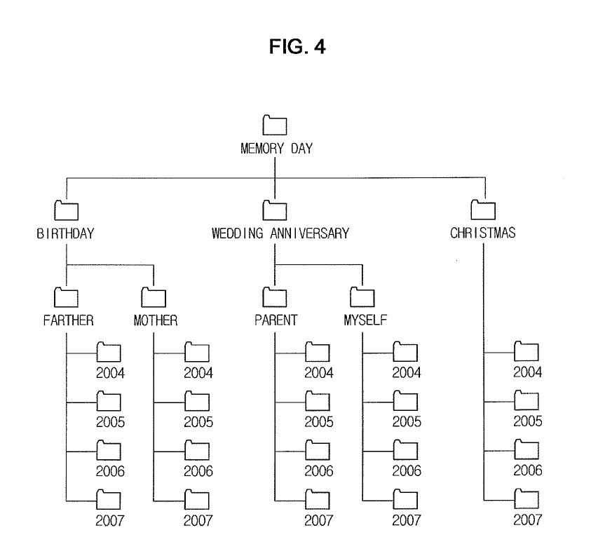

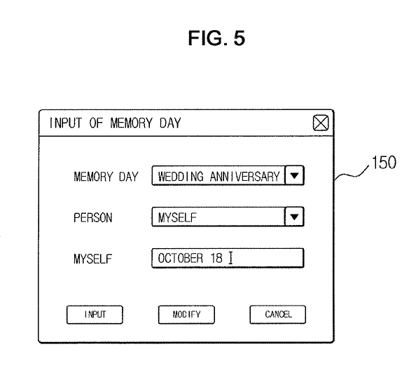

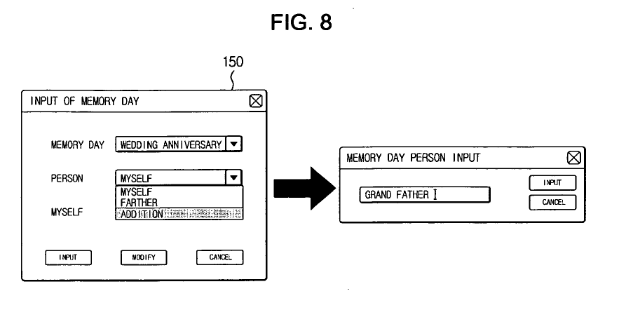

The controller 130 searches the storage unit 120 for the memory day log file if the input of a memory day is selected. If the memory day log file exists in the storage unit 120, the controller 130 opens the memory day log file, extracts information about a type (MAIN TITLE), a person (SUB TITLE), and a date (DAY) of a memory day from the memory day log file, and then provides a memory day input window such that folders are automatically created according to types of the memory day by using the extracted information as illustrated in FIG. 4 (see also FIGS. 5 and 8).

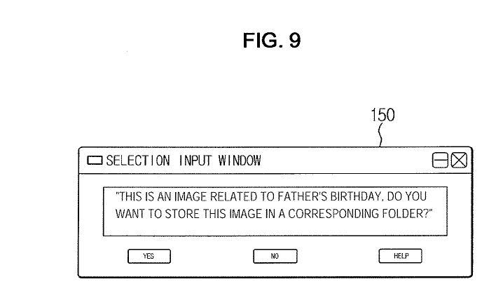

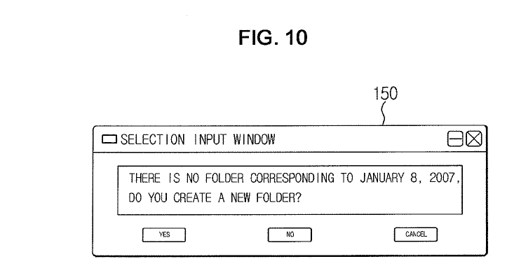

Thereafter, the controller 130 compares a date of an image file transferred from the storage medium 200 through the interface unit 110 with a preset date of a memory day. If the date of the memory day identical to the date of the image file exits, a selection input window is provided such that the image file is stored in a folder corresponding to the date of the memory day (see FIGS. 9 and 10).

The input unit 140 is a user interface to input data from a user through a memory day input window or a selection input window provided by the controller 130, and the user sets several functions, which are supported by the image forming apparatus 100, and inputs various kinds of commands required for the operation of the image forming apparatus 100 through the input unit 140. The commands input through the input unit 140 can be delivered to the controller 130 through a system bus.

The display unit 150 is a user interface displaying the memory day input window or the selection input window provided by the controller 130 to a user, and the user can recognize information about the operation of the image forming apparatus 100 through displayed characters or graphics. The display unit 150 may include a cathode ray tube (CRT) or a liquid crystal display (LCD), and the user can recognize a realization state and a realization result of the image forming apparatus 100 by using a UI (user interface) window displayed on the display unit 150. In addition, the display unit 150 can display image files stored in memory day folders of the storage unit 120 according to the memory day folders.

The printing unit 160 prints out image files of the storage unit 120 on a recording sheet according to the control signal of the controller 130. In this case, the printing unit 160 can print out image files according to the memory day folders.

FIG. 2 is a view illustrating a structure of the memory day log file used in the image forming apparatus 100 according to an embodiment of the present general inventive concept, and FIG. 3 is a view illustrating an example of the memory day log file used in the image forming apparatus 100.

As illustrated in FIGS. 2 and 3, the memory day log file is an image management file to allow a user to edit information about the type (MAIN TITLE), the person (SUB TITLE), and the date (DAY) of a memory day by using several keywords (e.g., MEMORY, MAIN TITLE, SUB TITLE, DAY, etc.). The memory day log file provides a function to allow a user to easily insert or modify a memory day wanted by the user.

Hereinafter, the keywords of the memory log file will be described in more detail. “MEMORY” represents that a birthday or a wedding anniversary exists.

“MAIN TITLE” is positioned in a next line of the keyword of “MEMORY”, and represents a main title (e.g., a birthday, a wedding anniversary, etc.), and “TITLE” that is a parameter of “MAIN TITLE” represents the name of the main title. For example, if the main title represents a birthday, “TITLE” is “birthday”, so that a folder named “birthday” is created at a lower layer of the memory day folder as illustrated in FIG. 4.

“SUB TITLE” is positioned in a next line of “MAIN TITLE”, and used to represent personal information (sub title) under a memory day (main title). SUB TITLE” is used in order to express information about each family member (sub title) under a birthday (main title). For example, in order to express a memory day (sub title) of each family member with respect to a birthday (main title), “SUB TITLE” may be used. The parameter of “SUB TITLE” represents a name (sub title) of a memory day of each family member, and a folder having the parameter of “SUB TITLE” as a name is crated at the lower layer of the folder of the main title.

“DAY” is positioned in a next line of a keyword of “SUB TITLE”, and used to express the date of a memory day.

Folders are created according to memory days prepared in the form of memory day log file and stored in the storage unit 120 as illustrated in FIG. 4.

For example, if a memory day corresponds to the birthday of father, the type of the memory day (MAIN TITLE) is a birthday, a person (SUB TITLE) of the memory day is father, and the date (DAY) of the memory day is “year/month/date”.

FIG. 4 is a view illustrating a structure of folders used to automatically manage image files according to one embodiment of the present general inventive concept. The folders are classified into higher-level folders representing main titles and lower-level folders representing sub titles. Lower-level folders named “Father”, “Mother”, “Parent”, and “Myself” may be created under the higher-level folders named “Birthday”, “Wedding anniversary”, and “Christmas”.

In addition, each of the lower-level folders may include other lower-level folders corresponding to years (e.g., 2004, 2005, 2006, 2007, etc.)

For example, if a user inputs “MAIN TITLE: Birthday,” “SUB TITLE_{—}1: Father,” “DAY_{—}1: Jan. 8, 2004,” “DAY_{—}2: Jan. 8, 2005,” “DAY_{—}3: Jan. 8, 2006,” “DAY_{—}4: Jan. 8, 2007,” “SUB TITLE_{—}2: Mother,” “DAY_{—}1: Jan. 13, 2004,” and “DAY_{—}2: Jan. 13, 2005” in order to create higher-level folders and lower-level folders, a folder named “Birthday” that is a main title is created, and lower-level folders named Father and Mother that are sub titles are automatically created under the Birthday folder.

In addition, folders related to years corresponding 2004, 2005, 2006, and 2007 are further created under the lower-level folders.

The folders are systematically managed by classifying the folders into high-level folders and lower-level folders as described above, so that image files on a specific day such as a memory day (e.g., birthday, wedding anniversary day, etc.) can be easily managed.

FIG. 5 is a first view illustrating a structure of the display unit illustrated in FIG. 1, and illustrates a memory day input window to input a memory day.

As illustrated in FIG. 5, if the input of a memory day is selected, the controller 130 analyzes a memory day log file of the storage unit 120 to provide the memory day input window such that a user can input the type (MAIN TITLE) of the memory day, the person (SUB TITLE) of the memory day, and the date (DAY) of a memory day into the memory day input window.

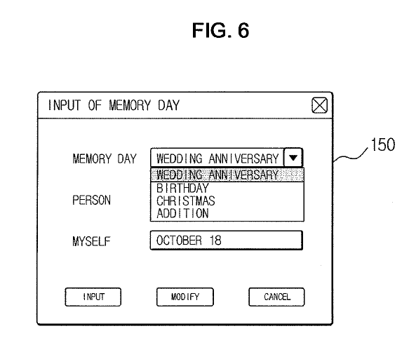

FIG. 6 is a second view illustrating the structure of the display unit illustrated in FIG. 1, and illustrates an example of a screen image in which a memory day is input.

As illustrated in FIG. 6, a “Birthday” item, a “Wedding anniversary” item, a “Christmas” item, or an “Addition” item can be input as the type of a memory day (MAIN TITLE), and then a modification button is pressed.

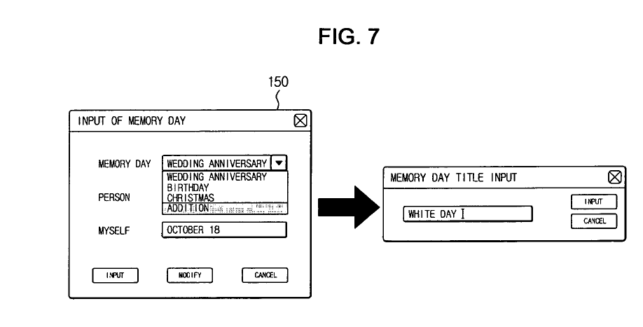

FIG. 7 is a third view illustrating the structure of the display unit illustrated in FIG. 1, and illustrates an example of a screen image in which the memory day is added.

As illustrated in FIG. 7, if an “Addition” item is selected in order to add the type of a memory day, a memory day addition input window is provided as displayed at the right side of FIG. 7, and a user personally inputs the title of the memory day through the memory day addition input window and then presses an input button.

FIG. 8 is a fourth view illustrating the structure of the display unit illustrated in FIG. 1, and illustrates an example of a screen image in which a memory day is added.

As illustrated in FIG. 8, “Myself”, or “Father” is input as the person (SUB TITLE) of a memory day, or an added input of the person (SUB TITLE) of the memory day can be selected. If the added input of the person of the memory day is selected, a person addition input window is displayed on the right side of FIG. 8, and a user personally inputs the person of the memory day through the person addition input window and then presses an input button.

FIG. 9 is a view illustrating a selection input window used to store an image file according to one embodiment of the present general inventive concept. If the date information of a memory day identical to the date information of an image file is stored in the storage unit 120, the controller 130 outputs information about a folder corresponding to the date information of the memory day into the selection input window to receive storage approval from a user.

For example, the selection input window outputs the information about the title of the folder corresponding to the date information of the memory day, such as a message of “This is an image related to Father's birthday, Do you want to store this image in a corresponding folder?”, and receives the storage approval of the image file from the user.

The image forming apparatus 100 to manage image files according to an embodiment of the preset general inventive concept receives selection input information from a user in order to store the image files. The selection input information represents user's selection of “Yes” or “No,” and the user may select help information displayed on the selection input window for additional information.

In addition, if the date information of the memory day identical to the date information of the image file is not stored in the storage unit 120, the controller 130 may create a folder corresponding to the date information of the image file and stores the image file in the created folder.

For example, if date information of a memory day identical to Jan. 8, 2006 that is date information of an image file is not stored in the storage unit 120, the controller 130 creates a folder corresponding to the date information of Jan. 8, 2006, and controls the image file to be stored in the created folder. The folder having the date information of Jan. 8, 2006 can be created in the storage unit 120 with the title of Jan. 8, 2006, and be changed into and stored as a title such as “0Birthday” or “Wedding Anniversary” through the input of the user.

Further, when the date information of the memory day identical to the date information of an image file does not exist in the storage unit 120, the controller 130 displays a predetermined failure message, which informs the failure in storage, on the display unit 150.

For example, when the date information of a memory day identical to Jan. 8, 2007, which is date information of an image file, does not exist in the storage unit 120, the controller 130 displays a predetermined failure message which informs the failure in storage as in an expression “There is no folder having the date information of Jan. 8, 2007”.

In addition, when the date information of the memory day identical to the date information of the image file does not exist in the storage unit 120, the controller 130 controls a selection input window for creating a folder to be displayed.

FIG. 10 illustrates a selection input window to display a failure message to inform of the failure in storage of an image and to create a folder according to one embodiment of the present general inventive concept.

As illustrated in FIG. 10, when the date information of a memory day identical to the date information of an image file does not exist in the storage unit 120, the controller 130 controls a selection input window to create a folder based on an expression “Do you want to generate a new folder?” to be output

When a user confirming the selection input window selects a button of “Yes,” the title of a folder can be input in order to create the folder.

Hereinafter, the operational procedure and effects of the image forming apparatus which automatically manages image files and a control method of the image forming apparatus will be described.

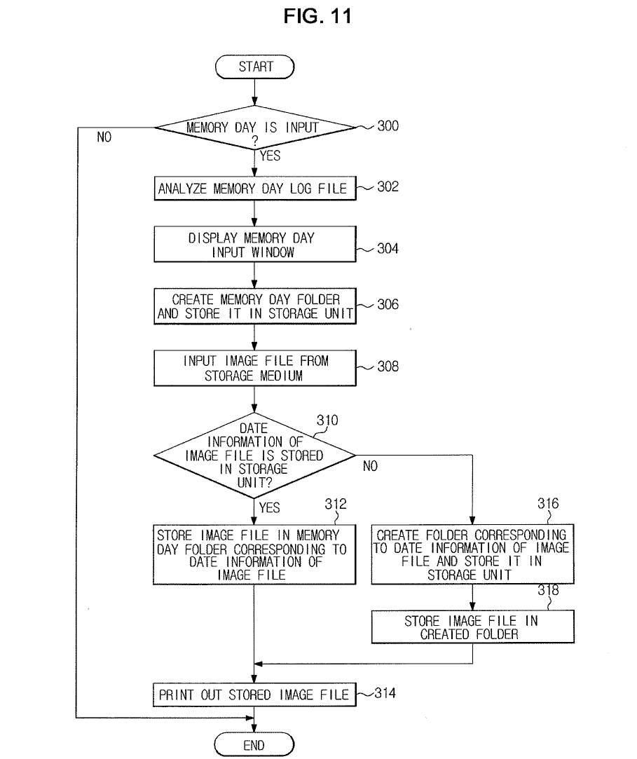

FIG. 11 is a flowchart illustrating a control method of the image forming apparatus which automatically manages image files according to one embodiment of the present general inventive concept.

As illustrated in FIG. 11, the controller 130 determines if an input of a memory day is selected in a menu in operation 300. If the input of the memory day is selected, the controller 130 searches the storage unit 120 for a memory day log file and analyzes the memory day log file in operation 302.

A illustrated in FIGS. 2 and 3, the memory day log file is an image management file allowing a user to edit information about a type (MAIN TITLE), a person(SUB TITLE), and a date (DAY) of a memory day by using several keywords (e.g., MEMORY, MAIN TITLE, SUB TITLE, DAY, etc.). The memory day log file provides a function to allow a user to easily create or modify a memory day wanted by the user.

The controller 130 analyzes the memory day log file, extracts information about the type (MAIN TITLE), the person (SUB TITLE), and the date of a memory day from the memory day log file, and then displays a memory day input window illustrated in FIG. 5 through the display unit 150 by using the extracted information in operation 304.

If the memory day input window of FIG. 5 is displayed through the display unit 150, a user selects or adds the title of a memory day as illustrated in FIGS. 6 and 7.

If the user selects a memory day or adds a new memory day, information about the added memory day is analyzed and it is determined if the memory day exists in the memory day log file. If the memory day exits in the memory day log file, the person and the date of the memory day are selected or added under the memory day and then the memory day log file is closed as illustrated in FIG. 8.

As illustrated in FIG. 4, the memory day folder is created and stored in the storage unit 120 through the above operation 306, and the memory day log file is closed.

Thereafter, the controller 130 receives an image file to be worked from the storage medium 200 through the interface unit 110 and determines if date information of a memory day identical to the date information of the image file is stored in the storage medium 120 in operation.

If the date information of the memory day identical to the date information of the image file is stored in the storage medium 120, the controller 130 stores the image file in a memory day folder corresponding to date information of the image file stored in the storage medium 120 as illustrated in FIG. 9 (operation 312), and selects the image file stored in the memory day folder to print out the image file through the printing unit 160 in operation 314.

If the date information of the image file is not stored in the storage unit 120 in operation 310, the controller 130 creates a folder corresponding to the date information to store the folder in the storage unit 120 as illustrated in FIG. 10 (operation 316).

Thereafter, the controller 130 stores the image file in the folder newly created in the storage unit 120 in operation 318, and selects an image file stored in the memory day folder to print the image file through the printing unit 160 in operation 314.

As described above, in the image forming apparatus and a control method thereof according to embodiments of the present general inventive concept, image files photographed on a memory day among image files photographed by a digital photographing device are easily managed, so that it is unnecessary for a user to individually search for image files photographed on a memory day.

In addition, according to the present general inventive concept, a classification function for image files photographed on a memory day is provided, so that the image files photographed on the memory day can be more easily classified.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A control method of an image forming apparatus, the control method comprising:
creating a memory day log file having a type and date information of a memory day;
comparing date information of an image file with the date information of the memory day log file; and
storing the image file by creating a second memory day folder to store the image file when a first memory day folder corresponding to the date information of the image file is not created.

2. The control method as claimed in claim 1, wherein a memory day folder corresponding to the date information of the memory day log file is created when the memory day log file is created.

3. The control method as claimed in claim 1, wherein the comparing of the date information comprises determining that the date information of the image file is identical to the date information of the memory day log file.

4. The control method as claimed in claim 1, wherein the storing of the image file comprises storing the image file in the first memory day folder when the first memory day folder corresponding to the date information of the image file is created.

5. The control method as claimed in claim 1, further comprising:
notifying a user of an absence of the first memory day folder corresponding to the date information of the image file when the first memory day folder is not created.

6. The control method as claimed in claim 1, further comprising:
printing the stored image file in a folder unit.

7. An image forming apparatus, comprising:
a storage unit which creates a memory day log file having a type and date information of a memory day; and
a controller which compares date information of an image file with the date information of the memory day log file so as to store the image file by creating a second memory day folder to store the image file when a first memory day folder corresponding to the date information of the image file is not created.

8. The image forming apparatus as claimed in claim 7, wherein the storage unit creates a memory day folder of the memory day log file when the memory day log file is created.

9. The image forming apparatus as claimed in claim 7, wherein the controller performs a control operation such that the image file is stored in the first memory day folder when the first memory day folder corresponding to the date information of the image file is created in the storage unit.

10. The image forming apparatus as claimed in claim 7, further comprising:
a display unit, wherein the controller controls the display unit to notify a user of an absence of the first memory day folder corresponding to the date information of the image file when the first memory day folder is not created.

11. The image forming apparatus as claimed in claim 7, further comprising:
an input unit which inputs a user's command to modify the memory day log file, wherein the controller receives a type and date information of a memory day to be modified by using the memory day log file through the input unit and modifies the first and second memory day folders according to the received information.

12. The image forming apparatus as claimed in claim 7, further comprising:
a printing unit, wherein the controller controls the printing unit to print out the image file in a folder unit.

13. A control method of an image forming apparatus, the control method comprises:
generating a memory day log file including memory day type and date information;
comparing date information of an image file to the date information of the memory day log file; and
storing the image file in a memory day folder,
wherein:
the image file is stored in a first memory day folder corresponding to the date information of the memory day log file when the date information of the memory day log file corresponds to the date information of the image file, and
the image file is stored in a second memory day folder generated to correspond with the date information of the image file when the date information of the memory day log file does not correspond to the date information of the image file.

14. The method of claim 13, where the image forming apparatus requests a user to generate the second memory day folder when the date information of the memory day log file does not correspond to the date information of the image file.

15. A control method of an image forming apparatus, the control method comprises:
determine whether date information of an image file is present;
analyze a memory day log file to determine whether the date information of the image file corresponds to date information of the memory day log file;
store the image file in a memory day folder corresponding to the date information of the image file.

16. The method of claim 15, wherein the image file is stored in a first memory day folder corresponding to the date information of the memory day log file when the date information of the image file corresponds to date information of the memory day log file.

17. The method of claim 15, wherein a second memory day folder is generated to store the image file when the date information of the image file does not correspond to date information of the memory day log file.

18. The method of claim 15, wherein image files within a memory day folder are further stored in sub-folders corresponding to a type, sub-type, or sub-date information of the image file.
